(19) United States
(12) Patent Application Publication
(10) Pub. No.: US 2023/0256722 A1
(43) Pub. Date: Aug. 17, 2023

(54) POLARIZING FILM AND METHOD FOR MANUFACTURING SAME

(71) Applicant: Choong Deuk KIM, Suwon-si, Gyeonggi-do (KR)

(72) Inventor: Choong Deuk KIM, Suwon-si, Gyeonggi-do (KR)

(21) Appl. No.: 18/017,195

(22) PCT Filed: Aug. 3, 2020
(86) PCT No.: PCT/KR2020/010186

§ 371 Date: Jan. 20, 2023

(30) Foreign Application Priority Data
Jul. 27, 2020 (KR) 10-2020-0092842

(51) Int. Cl. B32B 27/08; C09J 5/00; C08J 7/16; G02B 1/14; B32B 37/12; B32B 27/36; B32B 7/12; B32B 27/30; B32B 27/16

(52) U.S. Cl. CPC B32B 27/08; C09J 5/00; C08J 7/16; G02B 1/14; B32B 37/1284; B32B 27/365; B32B 7/12; B32B 27/306; B32B 27/16; C09J 2469/008; C09J 2431/008; B32B 27/32

(57) ABSTRACT

Proposed are a method of manufacturing a polarizing film and the polarizing film thereto that is not harmful to the human body by making the surface of a PC film hydrophilic, and laminating it with a PVA film using water-based adhesive on the surface of the hydrophilic PC film, in manufacturing the polarizing film by laminating a polycarbonate (PC: polyvinyl alcohol) film and a polyvinyl alcohol (PVA: polyvinyl alcohol) film constituting the polarizing film.

### TECHNICAL FIELD

The present invention relates to a polarizing film and a manufacturing method thereof, and more particularly, to a method of manufacturing the polarizing film and a polarizing film thereto that is not harmful to the human body by making the surface of a PC (PC: polyvinyl alcohol) film hydrophilic, and laminating it with a PVA (PVA: polyvinyl alcohol) film using water-based adhesive on the surface of the hydrophilic PC film, in manufacturing the polarizing film by laminating a PC film and a PVA film constituting the polarizing film.

### BACKGROUND ART

If natural light, which abstrusely repeats reflection and refraction by being reflected by natural objects, is accepted by eyes as they are, this may result in glare. In this case, the glare can be reduced by wearing a polarizing lens applying the principle of polarized light.

The polarized light here refers to a wave of light that transmits the natural light that abstrusely repeats reflection and refraction in only one direction through the polarizing film (polarizer) and vibrates only in a specific direction.

This polarizing lenses can reduce the glare by blocking reflected light and refracted light at sunrise or sunset, and increase the viewing distance of objects.

In addition, when a drive wears the polarizing lenses while driving vehicles, this blocks unnecessary light, to secure a wide field of view, which helps safe driving.

A typical polarizing lens is made by the method of using a casting method in which the polarizing film (polarizer) is heated and attached to the surface of a plastic or glass lens, the polarizing film is pre-formed into a lens shape, and then CR-39 (allyl diglycol coating) or a liquid monomer or oligomer such as urethane is poured on both sides of the polarizing film to cure, or by the method that after molding a polarizing sheet of laminating (laminating) a protective film such as polycarbonate film on both sides of the polarizing film into a lens shape, the molded polarizing sheet is placed in an injection machine to reinforce the thickness through insert injection. In particular, in the case of the polarizing films for sunglasses, there is a problem that when TAC (Tri Acetyl Cellulose) film is attached to the polarizing film, it breaks easily, so a strong PC film has been attached to the polarizing film.

In the case of laminating a conventional PC film and a PVA film, the PC film is fat-soluble and the PVA film is water-soluble, in order to laminate them together, the polyurethane resin had to be laminated with a polyurethane resin adhesive diluted with a solvent.

However, when the polarizing lenses are manufactured by using the polarizing film diluted with the solvent on polyurethane resin, there is a problem in that the solvent remaining in the polarizing lens is harmful to the human body.

Also, when diluting the polyurethane resin with the solvent, there was also a problem that some volatile solvents could not escape during the drying phase after laminating, and defects in the PC and PVA lamination could occur.

Also, when the solvent is not used for the polyurethane adhesive, the PC film must be coated with a polyurethane adhesive, and there is a problem that PC film coating facilities are required, and the manufacturing cost is increased.

### DETAILED DESCRIPTION OF THE INVENTION

### Technical Problem

The present invention is designed to solve the problems described above, and is to provide the polarizing film and the manufacturing method thereof, characterized in that the composite of PC and PVA film is made of a conventional water-soluble adhesive, by surface-modifying the surface of the fat-soluble PC film to the water-soluble surface, in laminating the PC film and the PVA film.

### Solution to Problem

In order to achieve the purpose, the present invention provides the polarizing film consisting of the PVA film and the PC film portion with a hydrophilic surface treatment bonded to both sides of the PVA film, wherein the PC film portion is attached to the PVA film with a water-based adhesive.

In the present invention, the hydrophilic surface treatment is characterized by saponifying the surface of the PC film portion by immersing an aqueous solution consisting of 2-7% concentration of 3-aminopropyltriethoxysilane at 40 to 60° C. for 1 to 3 minutes.

In the present invention, the PC film portion immersed in the aqueous solution may be composed of the PC film and the protective film attached to the PC film, and one side of the PC film to which the protective film is attached is not be hydrophilized.

In the present invention, the water-based adhesive may be any one of a polyvinyl alcohol adhesive, a polyethylene imine-based adhesive, a polycarboxyl-based adhesive, an epoxy adhesive, an aldehyde adhesive, and a water-dispersed polyurethane-based adhesive.

Also, in order to achieve the purpose, the present invention provides a method for manufacturing the polarizing film comprising: (a) treating one side of the PC film portion with the hydrophilic surface treatment; (b) drying the surface-treated PC film portion; and (c) manufacturing the polarizing film by attaching the dried PC film portion to both sides of the PVA film with the water-based adhesive.

In the present invention, the step (a) of treating the hydrophilic surface treatment comprises the steps: (a-1) dissolving 3-aminopropyltriethoxysilane in water to make the aqueous solution with a concentration of 2 to 7%; (a-2) heating the aqueous solution to a temperature of 40 to 60° C.; and (a-3) immersing the PC film portion in the heated aqueous solution for 1 to 3 minutes to conduct the saponification treatment.

In the present invention, the PC film portion may be composed of the PC film and the protective film attached to the PC film, and one side of the PC film to which the protective film is attached is not hydrophilized.

In the present invention, the water-based adhesive may be any one of the polyvinyl alcohol adhesive, the polyethylene imine-based adhesive, the polycarboxyl-based adhesive, the epoxy adhesive, the aldehyde adhesive, and the water-dispersed polyurethane-based adhesive.

### Effect of the Invention

As described above, the present invention has the advantage in that since the PC film and the PVA film can be laminated by using the water-soluble adhesive, a separate coating process is not required, thereby reducing costs consumed in manufacturing the polarizing film.

Also, the present invention has the advantage of not discharging harmful substances to the human body because no solvent is used when laminating the PC film and the PVA film.

Also, the present invention has the advantage of being able to manufacture the polarizing film with strong adhesion since coating defects due to the presence of volatile solvents do not occur when bonding the PC film and the PVA film.

Also, according to the present invention, the polarizing film with strong strength can be obtained because the PC film is used as the protective film.

### BRIEF DESCRIPTION OF DRAWINGS

FIG. 1 is a configuration diagram explaining a system for hydrophilically treating a surface of a PC film portion according to the present invention.

FIG. 2 is a configuration diagram of the PC film portion used in the system in FIG. 1.

FIG. 3 is a configuration diagram explaining the step for manufacturing the polarizing film according to the present invention.

FIG. 4 is a configuration diagram of the polarizing film manufactured through the configuration in FIG. 3.

### BEST MODES OF THE INVENTION

The best mode for implementing the present invention consists of the PVA film and the PC film portion having the hydrophilic surface treatment adhering to both sides of the PVA film, and the PC film portion is attached to the PVA film with a water-based adhesive, and

The manufacturing method comprises the steps of (a) treating one side of the PC film portion with the hydrophilic surface treatment; (b) drying the surface-treated PC film portion; and (c) manufacturing the polarizing film by attaching the dried PC film portion to both sides of the PVA film with the water-based adhesive.

### MODE FOR INVENTION

Hereinafter, a method of manufacturing the polarizing lenses according to one embodiment of the present invention will be specifically described by referring to the drawings as attached.

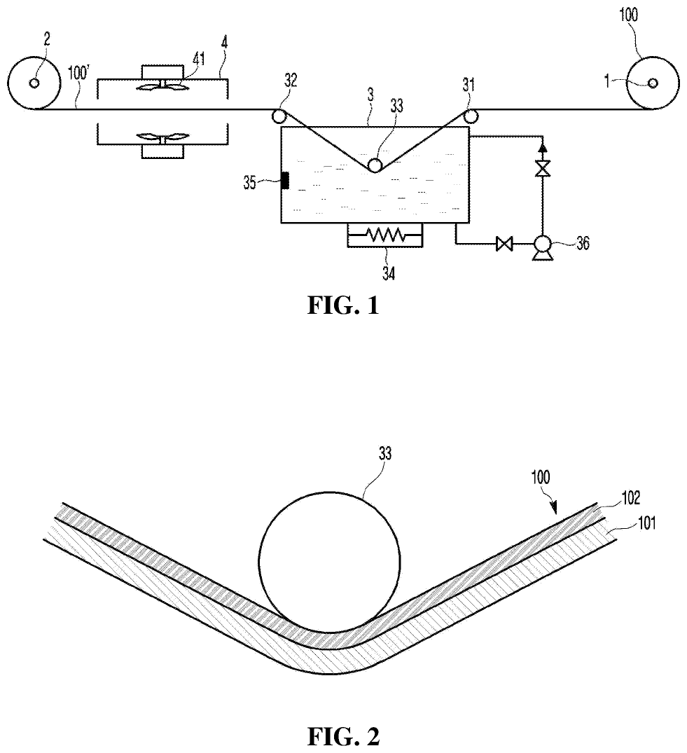

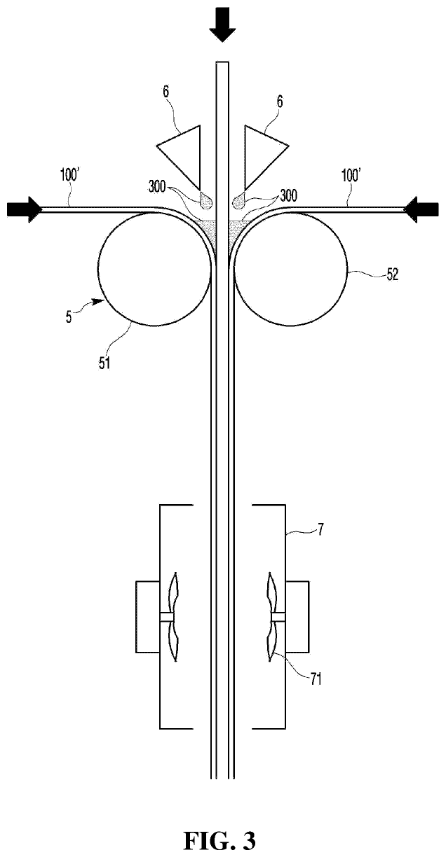

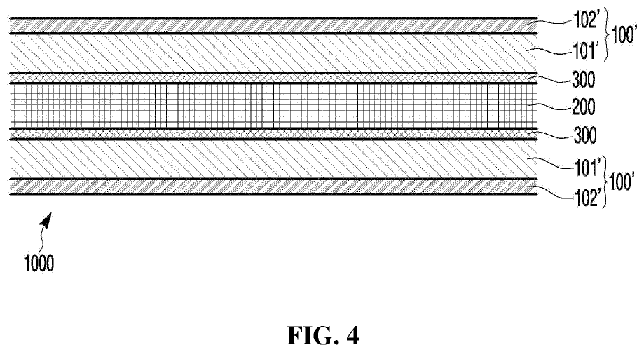

FIG. 1 is the configuration diagram explaining a system for hydrophilically treating the surface of the PC film portion according to the present invention, FIG. 2 is the configuration diagram of the PC film portion used in the system in FIG. 1, FIG. 3 is the configuration diagram explaining the step for manufacturing the polarizing film according to the present invention, and FIG. 4 is the configuration diagram of the polarizing film manufactured through the configuration of FIG. 3.

FIG. 1 explains a system for hydrophilically treating the surface of the PC film portion according to the present invention. As illustrated in the drawing, in order to treat the PC film portion (100) as hydrophilicity, one side of the PC film portion (100) is treated as hydrophilic through a roll-to-roll system. Specifically, it is composed of a first roll (1) wrapped around the PC film portion (100) before the hydrophilic treatment and a second roll (2) wrapped around the hydrophilic treated PC film portion (100′). Between the first roll (1) and the second roll (2), there is a water tank (3) for treating the PC film portion (100) with the hydrophilicity. A certain amount of solvent water and solute 3-minopropyltriethoxysilane (3-APTES) are injected into the water tank to form the aqueous solution. Furthermore, a drying section (4) is formed between the water tank and the second roll (2), and the drying section (4) is equipped with a fan or heater (41) to dry the hydrophilically treated PC film portion (100′) treated with the hydrophilicity.

Specifically, the PC film portion (100) is injected into the water tank (3) through the first roll (1). The aqueous solution in which 3-APTES is diluted to a concentration of 2 to 7% is prepared in the water tank. The temperature of the aqueous solution is heated to 40 to 60° C. When the aqueous solution reaches a constant concentration and temperature, the first roll (1) and the second roll (2) are driven. When the first roll (1) and the second roll (2) are driven, the PC film portion (100) is injected into the water tank at a fixed length. The PC film portion (100) injected into the water tank is kept immersed in the water tank for a certain period of time so that a saponification reaction occurs on the surface of the film. The time immersed in the water tank is about 1 to 3 minutes. When the saponification reaction is performed on the surface of the PC film portion (100) while being immersed in the water tank for the certain period of time, the first roll (1) and the second roll (2) are driven to move the surface treatment PC film portion (100′) to the drying section (4). The surface treatment PC film portion (100′) is dried in the drying section (4), and the dried surface treatment PC film portion (100′) is wound in the second roll (2). The water tank (3) is composed of an inlet roll (31), an outlet roll (32), and an immersion roll (33), and may further be equipped with a heater (34) for heating the aqueous solution in the water tank (3). Also, a circulation pump (36) that circulates the lower aqueous solution to the upper part so that the temperature in the water tank (3) can be kept constant may be further provided. Also, a sensor unit (35) can be further provided as needed, and the sensor unit (35) can be divided into temperature and then installed, water level, and concentration sensors. Also, a length sensor is designed for the inlet roll (31) and the outlet roll (32), so that a fixed length can be supplied by measuring the length of the PC film portion (100) passing through each roll.

FIG. 2 illustrates that the protective film (102) is attached to one side so that the saponification reaction of the PC film portion (100) occurs only on one side. In other words, the PC film portion (100) consists of the PC film (101) and the protective film (102), and since the PC film (101) is non-hydrophilic, it can only be attached to the PVA film using the fat-soluble adhesive such as the polyurethane diluted with an organic solvent. However, if the surface of the PC film (101) becomes hydrophilic, it can be attached to a hydrophilic PVA film. To change the surface of the PC film (101) to a hydrophilic, the aqueous solution in which 3-APTES has been diluted is used, and the protective film (102) is attached to the opposite side to change only one surface of the PC film (101) to hydrophilic. The protective film (102) can use polyethylene or the like.

The saponification reaction is specifically described as follows.

The polycarbonate resin has a structural formula as follow.

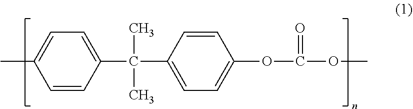

From the structural formula (1), it can be seen that polycarbonate has an ester functional group, and the saponification reaction refers to the reverse reaction of an ester and is generally called the saponification reaction. The saponification refers to the reaction in which an ester reacts with water to form a carboxylic acid and an alcohol. The saponification reaction of polycarbonate resins promotes the reaction by adding an acid or alkali as a promoter to react with water. In the present invention, the PC film, which is the polycarbonate resin, is immersed in the aqueous solution in which 3-APTES is diluted to induce the saponification reaction, and the protective film (102) is attached to the other side so that the saponification reaction occurs only on one side of the PC film not to occur the saponification reaction. The 3-APTES is soluble in water and organic solvents, and hydrolyzes in water to make the aqueous solution alkaline.

The reverse reaction formula for esterification is as follows.

RCOOR′+H2RCOOH+R′OH(R,R′=alkyl group) (2)

As illustrated in the reaction formula (2), the ester functional group reacts with water to form carboxylic acid and alcohol, and since both carboxylic acid and alcohol have a hydroxyl group, when the PC film is saponified, it may be attached to the hydrophilic PVA film.

FIG. 3 illustrates the step of bonding the surface treatment PC film portion (100′) and the PVA film (200) using the water-based adhesive (300). The figure illustrates that the surface treatment PC film portion (100′) is injected into both sides of the PVA film (200) and the PVA film (200) through a roller section (5). The surface treatment PC film portion (100′) with the protective film attached to both sides of the PVA film (200) is supplied, and the water-based adhesive (300) is also injected through an adhesive injector (6). It is illustrated that the PVA film (200) and the surface treatment PC film portion (100′) are inserted together and pressed and bonded by one side roller (51) which is the roller portion (5) and the other roller (52), and are inserted into the drying part (7). Since it is pressed with the water-based adhesive by a constant pressure of the roller part (5) and dried directly in the drying part (7) after being pressed, no volatile solvent is used in the polarizing film (1000), thereby ensuring the quality of the product. In other words, since there is no need to discharge solvent gas due to a gas barrier (gas barrier) function of the PC film, the quality of the polarizing film can be guaranteed. The water-based adhesive used in the present invention can use any of the following: the polyvinyl alcohol adhesive, the polyethylene imine-based adhesive, the polycarboxyl-based adhesive, the epoxy adhesive, aldehyde-based adhesives, and the water-dispersed polyurethane-based adhesives. Also, in the present invention, a colorless or colored polarizing film can be used for the PVA film (200). Also, PC films (101, and 101′) can also be used as colorless or colored films.

FIG. 4 illustrates the polarizing film (1000) according to the present invention. The polarizing film (1000) according to the present invention consists of a PVA film layer (200), an adhesive layer (300) formed on both sides of the PVA film layer (200), a PC film layer (101′) bonded to both sides of the adhesive layer (300), and a protective film layer (102′) covering the PC film layer (101′).

The table below shows experimental results data for measuring the strength of the polarizing film (1000) manufactured according to the present invention under certain conditions. The experimental conditions measured tensile strength, which is the adhesion of the sample according to a constant temperature and % concentration of 3-APTES, after aging the manufactured polarizing film (1000) for 3 days.

TABLE 1

| Aqueous solution | 3-APTES (% | Tensile strength |
|---|---|---|
| temperature (° C.) | concentration) | (kgf/mm²) |
| 40 | 3.5 | 0.0147 |
| | 4.5 | 0.1151 |
| | 5.5 | 0.0978 |
| | 6.5 | 0.062 |
| | 7.5 | 0.0135 |

Table 1 is one embodiment of surface treatment of the PC film portion (100) for each concentration of the 3-APTES while maintaining the temperature of the aqueous solution at 40° C., and testing the tensile strength of the polarizing film 1000 manufactured using the surface-treated PC film part 100′. In Table 1, it can be seen that the concentration of 3-APTES at a temperature of 40° C. has the greatest tensile strength value, when the concentration of 3-APTES has 4.5%.

TABLE 2

| Aqueous solution | 3-APTES (% | Tensile strength |
|---|---|---|
| temperature (° C.) | concentration) | (kgf/mm²) |
| 50 | 3.5 | 0.1156 |
| | 4.5 | 0.2645 |
| | 5.5 | 0.3265 |
| | 6.5 | 0.1631 |
| | 7.5 | 0.1321 |

Table 2 shows one embodiment in which the PC film portion (100) was surface-treated for each concentration of the 3-APTES while maintaining the temperature of the aqueous solution constant at 50° C., and the tensile strength of the polarizing film (1000) manufactured by using the surface-treated PC film portion (100′) was tested. In the Table 2, it can be seen that at a temperature of 50° C., the concentration of 3-APTES has the greatest tensile strength value when the concentration of 3-APTES is 5.5%.

TABLE 3

| Aqueous solution | 3-APTES (% | Tensile strength |
|---|---|---|
| temperature (° C.) | concentration) | (kgf/mm²) |
| 60 | 3.5 | 0.3465 |
| | 4.5 | 0.5321 |
| | 5.5 | 1.0481 |
| | 6.5 | 0.4684 |
| | 7.5 | 0.438 |

Table 3 shows one embodiment in which the PC film portion (100) was surface-treated for each concentration of the 3-APTES while maintaining a constant temperature of the aqueous solution at 60° C., and the tensile strength of the polarizing film (1000) manufactured by using the surface treatment PC film portion (100′) was tested. In Table 3, it can be seen that at a temperature of 60° C., the concentration of 3-APTES has the greatest tensile strength value when the concentration of 3-APTES is 5.5%. As can be seen from [Table 1] to [Table 3] above, it can be seen that the higher the temperature of the aqueous solution, the better the result of 3-APTES at the concentration of 4.5 to 5.5%. Accordingly, since the higher the temperature of the aqueous solution, the greater the tensile strength, the temperature can also be seen to act as the promoter of the saponification reaction. Also, in the case of 3-APTES, which is the promoter, it can be found that the strength is advantageous to have a concentration of 4.5 to 5.5% so that the concentration can be maintained properly instead of getting considerably high.

However, the higher the temperature of the aqueous solution, the more the saponification reaction of the PC film portion (100) can be promoted, but the temperature of 60° C. or higher may damage the circulation pump to maintain the temperature of the aqueous solution, so it was not measured at a temperature above that.

Although the preferred embodiment of the present invention has been described above, it is clear that the present invention can use various changes, alteration, and uniformity, and that the embodiment can be appropriately modified and applied in the same way. Therefore, the above description does not limit the scope of the present invention as determined by the limitations of the following claims.

### INDUSTRIAL AVAILABILITY

The present invention is a highly industrially applicable invention that can strengthen the strength of the polarizing film and provide convenience in manufacturing by directly bonding the fat-soluble PC film to the water-soluble PVA film.

1. A polarizing film comprising a PVA film, and a PC film portion having a hydrophilic surface treatment bonded to both sides of the PVA film, wherein the PC film portion is attached to the PVA film with a water-based adhesive.

2. The polarizing film of claim 1, wherein that the hydrophilic surface treatment is done by a saponification processing the surface of the PC film portion, by immersing for 1-3 minutes in the aqueous solution of 40° C. to 60° C. with a concentration of 3-aminopropyltriethoxysilane 2 to 7%.

3. The polarizing film of claim 2, wherein that the PC film portion immersed in the aqueous solution is composed of the PC film and a protective film attached to the PC film, and one side of the PC film to which the protective film is attached is not be hydrophilized.

4. The polarizing film of claim 3, wherein that the water-based adhesive is one of polyvinyl alcohol adhesive, polyethylene imine-based adhesive, polycarboxyl-based adhesive, epoxy adhesive, aldehyde-based adhesive, and water-dispersed polyurethane-based adhesive.

5. A method for manufacturing the polarizing film, the method by comprising:
(a) treating one side of the PC film portion with the hydrophilic surface treatment;
(b) drying the surface-treated PC film portion; and
(c) manufacturing the polarizing film by attaching the dried PC film portion to both sides of the PVA film with the water-based adhesive;

6. The method for manufacturing the polarizing film of claim 5, wherein the step (a) of the hydrophilic surface treatment comprises:
(a-1) dissolving the 3-aminopropyltriethoxysilane in water to make the aqueous solution with the concentration of 2 to 7%;
(a-2) heating the aqueous solution to a temperature of 40 to 60° C.; and
(a-3) performing the saponification processing by immersing the PC film portion in the heated aqueous solution for 1 to 3 minutes.

7. The method for manufacturing the polarizing film of claim 6, wherein the PC film portion is formed of the PC film and the protective film attached to the PC film, and one side of the PC film to which the protective film is attached is not be hydrophilized.

8. The method for manufacturing the polarizing film of claim 7, wherein the water-based adhesive is one of the polyvinyl alcohol adhesive, the polyethylene imine-based adhesive, the polycarboxyl-based adhesive, the epoxy adhesive, the aldehyde adhesive, and the water-dispersed polyurethane-based adhesive.
